(19) United States
(12) Patent Application Publication
(10) Pub. No.: US 2010/0121804 A1
(43) Pub. Date: May 13, 2010

(54) PERSONALITY-SENSITIVE EMOTION REPRESENTATION SYSTEM AND METHOD THEREOF

(75) Inventors: Che-Wei Kang, Tainan County (TW); Yu-Sheng Lai, Tainan City (TW); Yi-Hsin Cheng, Tainan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/388,567

(22) Filed: Feb. 19, 2009

(30) Foreign Application Priority Data
Nov. 11, 2008 (TW) 97143591

(51) Int. Cl. G06N 5/02

(52) U.S. Cl. 706/46

(57) ABSTRACT

A personality-sensitive emotion representation system and method thereof are provided. The personality-sensitive emotion representation system comprises a behavior database, a behavior selection module and a behavior modification module. The behavior selection module selects a set of behavior parameters from the behavior database according to an emotion parameter which represents an input emotion. The behavior modification module modifies the set of behavior parameters according to the personality parameter so as to output a set of personality-sensitive behavior parameters.

This application claims the benefit of Taiwan application Serial No. 97143591, filed Nov. 11, 2008, the subject matter of which is incorporated herein by reference.

### BACKGROUND OF THE INVENTION

1. Field of the Invention

The invention relates in general to an emotion representation system and method thereof, and more particularly to a personality-sensitive emotion representation system and method thereof.

2. Description of the Related Art

Interactive toys have been provided for a period of time. The current best sale “electronic pet” is among one of the interactive toys. Despite the interactive toy has gained a great popularity now, all interactive toys are facing the same problem, that is, the behavior of the interactive toy is rigid either being one command one action or a monotonous response to a fixed behavior. As personalized effect is absent, the toy is not so enjoyable. As the electronic toy is normally an embedded system, complicated operations cannot be achieved and the behavior is limited to a monotonous response. Thus, how to provide an interactive toy with personalized effect has become an imminent issue to the manufacturers.

### SUMMARY OF THE INVENTION

The invention is directed to a personality-sensitive emotion representation system and method thereof. Emotions and personality are applied to the electronic device using the same through simple calculation, not only creating more personalized effect to the electronic device using the same but also making the user enjoying more fun during operation and making the electronic device more enjoyable.

According to a first aspect of the present invention, a personality-sensitive emotion representation system is provided. The emotion representation system comprises a behavior database (BDB), a behavior selection (BS) module and a behavior modification (BM) module. The behavior selection module selects a set of behavior parameters from the behavior database according to emotion parameter which represents an input emotion. The behavior modification module modifies the set of behavior parameters according to the personality parameter so as to output a set of personality-sensitive behavior parameters.

According to a second aspect of the present invention, a personality-sensitive emotion representation method is provided. The emotion representation method comprises the following steps. Firstly, a set of behavior parameters is selected from a behavior database according to an emotion parameter, which represents an input emotion. Next, the set of behavior parameters is modified according to a personality parameter so as to output a set of personality-sensitive behavior parameters.

The invention will become apparent from the following detailed description of the preferred but non-limiting embodiments. The following description is made with reference to the accompanying drawings.

### BRIEF DESCRIPTION OF THE DRAWINGS

FIG. 1 shows a PAD 3-D emotion model;

FIG. 2 shows a personality-sensitive emotion representation system according to a preferred embodiment of the invention;

FIG. 3 shows an input emotion in a PAD 3-D emotion model;

FIG. 4 shows a data format of the behavior database;

FIG. 5 shows a comparison table of behavior parameters for the same emotion under different personalities,

FIG. 6 shows a flowchart of a personality-sensitive emotion representation method.

### DETAILED DESCRIPTION OF THE INVENTION

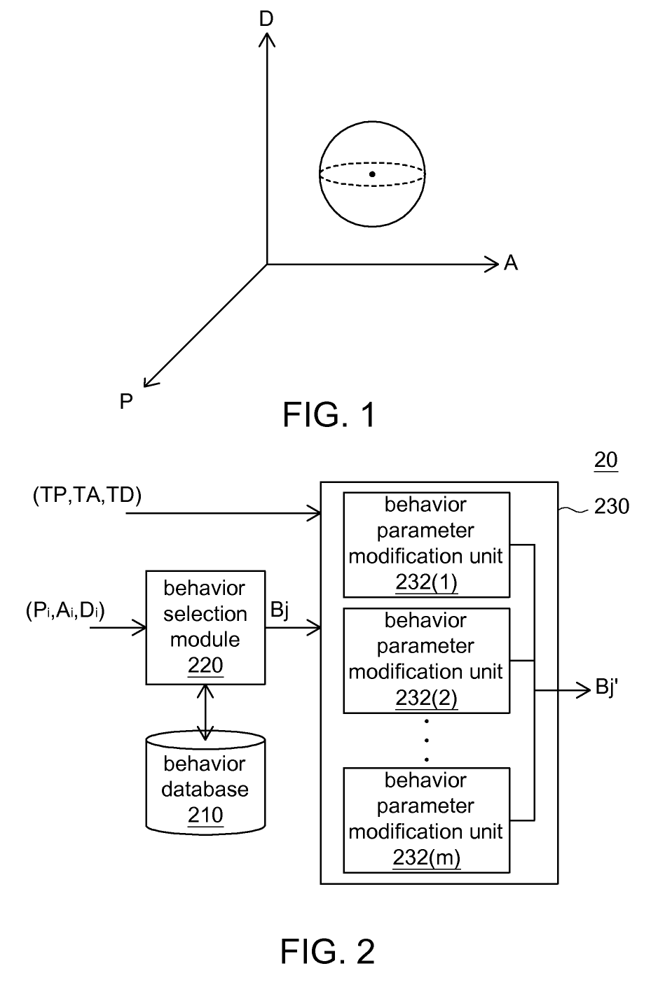

Referring to FIG. 1, a PAD 3-D emotion model is shown. The PAD 3-D emotion model was disclosed by Mehrabian and Russell in 1974. The dimension P, dimension A, dimension D of the PAD 3-D emotion model respectively denote pleasure, arousal and dominance. The value of each dimension ranges between −1 and +1, wherein +1 denotes the maximum in the dimension and −1 denotes the minimum in the dimension. Therefore, each point in the PAD 3-D emotion model can be represented by the emotion parameters constituted by the values in the three dimensions. Besides, each emotion has a spacial distribution in the PAD 3-D emotion model, and the spatial distribution of the emotion can be denoted by its average value and standard error. For example, if the average value for pleasure is (0.81, 0.51, 0.46) and the standard error is (0.21, 0.26, 0.38), then the spatial distribution of pleasure in the PAD 3-D emotion model is as indicated in FIG. 1. If an emotion parameter falls within the spatial distribution of FIG. 1, then the emotion denoted by the emotion parameter may be pleasure.

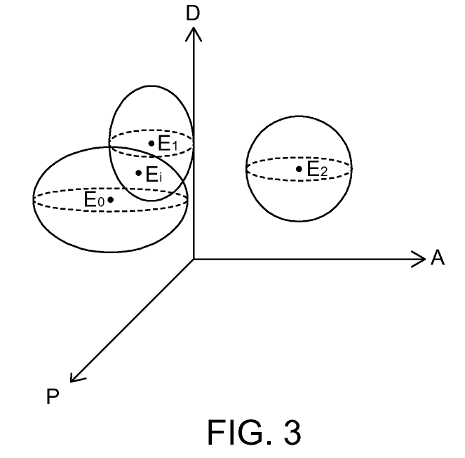

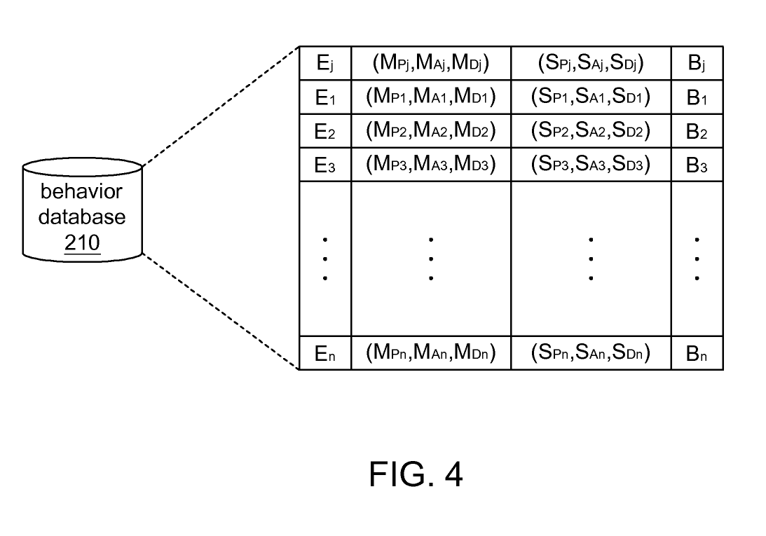

Referring to FIG. 2, FIG. 3 and FIG. 4. FIG. 2 shows a personality-sensitive emotion representation system according to a preferred embodiment of the invention. FIG. 3 shows an input emotion in a PAD 3-D emotion model. FIG. 4 shows a data format of the behavior database. The personality-sensitive emotion representation system 20 comprises a behavior database 210 (BDB), a behavior selection (BS) module 220 and a behavior modification (BM) module 230. The behavior database 210 is used for storing the average value (M_{Pj}, M_{Aj}, M_{Dj}) of the emotion Ej, the standard error (S_{Pj}, S_{Aj}, S_{Dj}) of the emotion Ej, and a set of behavior parameters Bj corresponding to the emotion Ej, wherein j equals 1˜n. Each set of behavior parameter Bj is constituted by many behavior parameters. The behavior parameter denotes the speed rate, the response time or the behavior size of a behavior corresponding to the emotion Ej. The behavior selection module 220 receives the emotion parameter (Pi, Ai, Di), which represent an input emotion Ei. The behavior selection module 220 selects a set of behavior parameters Bj from the behavior database 210 according to the emotion parameter (Pi, Ai, Di). The behavior modification module 230 modifies the set of behavior parameters Bj according to the personality parameter (TP, TA, TD) so as to output a set of personality-sensitive behavior parameters Bj′.

There are many ways for inputting the above emotion parameter (Pi, Ai, Di). For example, changes in the surrounding or interaction with the user are sensed by a sensor, and then the sensed results are converted into a corresponding emotion parameter (Pi, Ai, Di). Or, the user directly sets the mode of the to-be-inputted emotion through an emotion input module.

Furthermore, the emotion parameter (Pi, Ai, Di) may fall within many emotions. Firstly, the behavior selection module 220 locates all the emotions relevant to the emotion parameter (Pi, Ai, Di) from the behavior database 210 according to emotion parameter (Pi, Ai, Di). Next, the emotion closest to the input emotion Ei is located from all the emotions relevant to the emotion parameter (Pi, Ai, Di). Lastly, the behavior parameter corresponding to the emotion closest to the input emotion Ei is selected. For example, the emotion parameter (Pi, Ai, Di) falls within the spatial distribution of emotion E0 and emotion E1 at the same time. The behavior selection module 220, first of all, locates the emotion E0 and emotion E1 from the behavior database 210 according to emotion parameter EP. Next, the behavior selection module 220 determines that the input emotion Ei corresponding to the emotion parameter (Pi, Ai, Di) is closest to the emotion E1. Lastly, the behavior selection module 220 selects the behavior parameter B1 corresponding to the emotion E1.

The behavior selection module 220 locates all the emotions relevant to the emotion parameter (Pi, Ai, Di) through the average value (M_{Pj}, M_{Aj}, M_{Dj}) and the standard error (S_{Pj}, S_{Aj}, S_{Dj}) of the emotion Ej stored in the behavior database 210 and the following formula (1):

Mₚⱼ−Sₚⱼ≦Pᵢ≦Mₚⱼ+Sₚⱼ

&M_{Aj}−S_{Aj}≦Aᵢ≦M_{Aj}+S_{Aj}

&M_{Dj}−S_{Dj}≦Dᵢ≦M_{Dj}+S_{Dj} (1)

After all the emotions relevant to the emotion parameter (Pi, Ai, Di) are located according to formula (1), the behavior selection module 220 selects the emotion closest to the input emotion Ei according to the distance or Gaussian distribution.

For example, the behavior selection module 220 calculates the distance Dist, that is, the distance from all the emotions relevant to the emotion parameter (Pi, Ai, Di) to the input emotion according to the following distance formula (2).

Dist=\sqrt{(Pᵢ−Mₚⱼ)²+(Aᵢ−M_{Aj})²+(Dᵢ−M_{Dj})²} (2)

After the behavior selection module 220 calculates the distance Dist from all the emotions relevant to the emotion parameter (Pi, Ai, Di) to the input emotion Ei according to the above distance formula (2), the behavior selection module 220 selects a set of behavior parameters Bj corresponding to the emotion with shortest distance.

Or, the behavior selection module 220 calculates the probability PP,A,D (P, A, D) of the input emotion Ei falling within all the emotions relevant to the emotion parameter (Pi, Ai, Di) according to the following formulae (3)˜(6), and then selects the emotion with maximum probability.

$$\begin{matrix}{p}_{P} ( Pi ) = \frac{1}{\sqrt{2 π {S}_{pj}}} {e}^{\frac{- {( {P}_{i} - {M}_{pj} )}^{2}}{2 {S}_{{p}_{j}}^{2}}} & ( 3 ) \\ {p}_{A} ( Di ) = \frac{1}{\sqrt{2 π {S}_{Dj}}} {e}^{\frac{- {( {D}_{i} - {M}_{Dj} )}^{2}}{2 {S}_{{D}_{j}}^{2}}} & ( 4 ) \\ {p}_{D} ( Ai ) = \frac{1}{\sqrt{2 π {S}_{Aj}}} {e}^{\frac{- {( {A}_{i} - {M}_{Aj} )}^{2}}{2 {S}_{{A}_{j}}^{2}}} & ( 5 ) \\ {p}_{P , A , D} = {P}_{P} ( {P}_{i} ) {P}_{A} ( {A}_{i} ) {P}_{D} ( {D}_{i} ) & ( 6 )\end{matrix}$$

The formulae (3)˜(5) respectively denote the Gaussian probability density function (PDF) on the dimension P, the dimension A, and the dimension D, and formula (6) denotes a joint probability. As the probability density function of Gaussian distribution calculates the probability of one-dimensional distribution only, the behavior selection module 220 calculates the probability of respective dimension according to formulas (3)˜(5) first, and then calculates the joint probability of the three dimensions according to formula (6) so to obtain the probability of the input emotion Ei falling within emotion Ej. After the behavior selection module 220 calculates the probability of the input emotion Ei falling within all the emotions relevant to the emotion parameter (Pi, Ai, Di) according to the above formulae (3)˜(6), the behavior selection module 220 selects a set of behavior parameters Bj corresponding to the emotion with largest probability.

The behavior modification module 230 modifies the behavior parameter Bj as a modified behavior parameter according to the personality parameter (TP, TA, TD), and determines whether the modified behavior parameter is within a pre-determined range. If no, then personality-sensitive behavior parameter Bj′ equals the extremum of the modified behavior parameter. If so, the personality-sensitive behavior parameter Bj′ equals modified behavior parameter.

The behavior modification module 230 further comprises m behavior parameter modification units 230(1)˜230(m). The behavior parameter modification units 230(1)˜230(m) respectively modify each behavior parameter of the set of behavior parameters Bj according to the personality parameter (TP, TA, TD). For example, the behavior parameter Bj comprises a speed rate behavior parameter, a response time behavior parameter or a behavior size behavior parameter and the behavior parameter modification units 230(1)˜230(m) comprise a speed modification unit used for modifying speed rate behavior parameter, a response time modification unit used for modifying response time behavior parameter or a behavior size modification unit used for modifying behavior size behavior parameter.

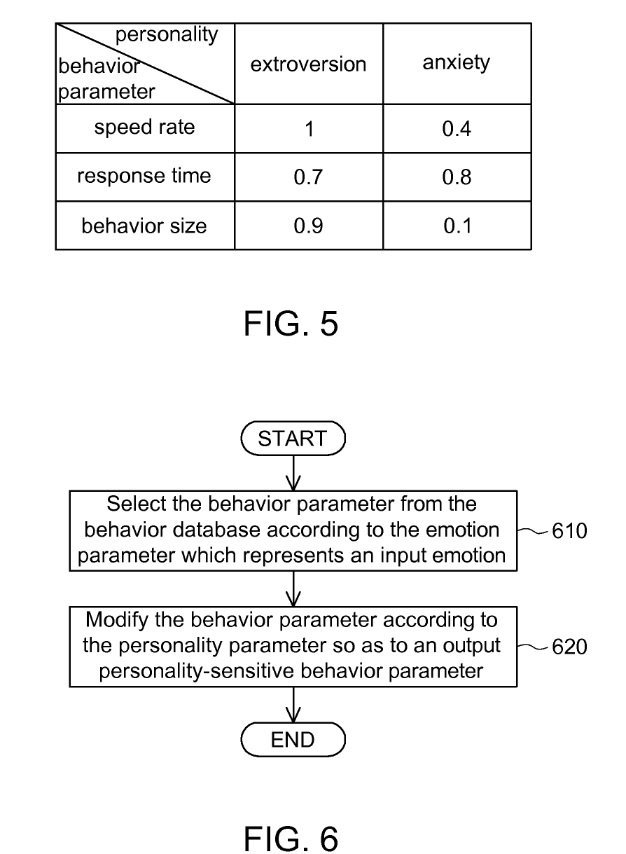

Referring to FIG. 5, a comparison table of behavior parameters for the same emotion under different personalities is shown. The personality-sensitive emotion representation system 20 can be used in an electronic device controlled by a servo motor, and the electronic device is an interactive toy for example. Let the emotion parameter (Pi, Ai, Di) denote pleasure by (0.81, 0.51, 0.46). The behavior selection module 220 selects the behavior parameter Bj according to the emotion parameter (0.81, 0.51, 0.46), wherein, the speed rate behavior parameter of the behavior parameter Bj is Bj_{speed}=0.8, the response time behavior parameter of the behavior parameter Bj is Bjᵣₑₛₚₒₙₛₑ=0.5 and the behavior size behavior parameter of the behavior parameter Bj is Bjₘₒₜᵢₒₙ=0.4.

The behavior modification module 230 can calculate the personality-sensitive behavior parameter Bj′ through the following modification function (7):

Bj′=f(Bj, TP, TA, TD) (7)

Wherein, the modification function (7) comprises the following formulae including formula (8) for modifying speed rate, formula (9) for modifying response time and formula (10) for modifying behavior size.

Bj′_{speed}=Bj_{speed}+(TP×0.5+T×0.5) (8)

Bj′ᵣₑₛₚₒₙₛₑ=Bjᵣₑₛₚₒₙₛₑ+(TA×1) (9)

Bj′ₘₒₜᵢₒₙ=Bjₘₒₜᵢₒₙ+(TD×1) (10)

When personality is extrovert, the personality parameter (TP, TA, TD) denoting extroversion is (0.21, 0.17, 0.5), and the behavior modification module 230 respectively calculates Bj′_{speed}=0.8+(0.21×0.5+0.5×0.5)=1.15, Bj′ᵣₑₛₚₒₙₛₑ=0.5+(0.17×1)=0.67, Bj′ₘₒₜᵢₒₙ=0.4+(0.5×1)=0.9 according to formulae (8)˜(10). In FIG. 5, the speed rate behavior parameter Bj′_{speed}, the response time behavior parameter Bj′ᵣₑₛₚₒₙₛₑ and the behavior size behavior parameter Bj′ₘₒₜᵢₒₙ for extrovert personality are respectively denoted by approximated values 1, 0.7 and 0.9.

Similarly, when the personality is extrovert, the personality parameter (TP, TA, TD) denoting introversion is (−0.43, 0.29, −0.37), and the behavior modification module 230 respectively calculates

Bj′_{speed}=0.8+(−0.43×0.5+(−0.37×0.5))=0.4, B′ᵣₑₛₚₒₙₛₑ=0.5+(0.79×1),

Bj′ₘₒₜᵢₒₙ=0.4+(−0.37×1)=0.9 according to formulae (8)˜(10). In FIG. 5, the speed rate behavior parameter Bj′_{speed}, the response time behavior parameter Bj′ᵣₑₛₚₒₙₛₑ and the behavior size behavior parameter Bj′ₘₒₜᵢₒₙ for extrovert personality are respectively denoted by approximated values 0.4, 0.8 and 0.1.

Thus, the personality-sensitive emotion representation system 20 can apply emotions and personality to the electronic device using the same through simple calculation, not only creating more personalized effect to the electronic device using the same but also making the user enjoying more fun during operation and making the electronic device more enjoyable.

Referring to FIG. 6, a flowchart of a personality-sensitive emotion representation method is shown. The emotion representation method applicable to the emotion representation system 20 at least comprises the following steps. Firstly, the method begins at step 610, the behavior selection module 220 selects the behavior parameter Bj from the behavior database 210 according to the emotion parameter (Pi, Ai, Di), which represents an input emotion Ei. Next, the method proceeds to step 620, the behavior modification module 230 modifies the behavior parameter Bj according to the personality parameter (TP, TA, TD) so as to an output personality-sensitive behavior parameter Bj′.

According to the personality-sensitive emotion representation system and method thereof disclosed in the above embodiment of the invention, emotions and personality are applied to the electronic device using the same through simple calculation, not only creating more personalized effect to the electronic device using the same but also making the user enjoying more fun during operation and making the electronic device more enjoyable.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A personality-sensitive emotion representation system, comprising:
a behavior database (BDB);
a behavior selection (BS) module used for selecting a set of behavior parameters from the behavior database according to an emotion parameter which represents an input emotion; and
a behavior modification (BM) module used for modifying the set of behavior parameters according to a personality parameter so as to output a set of personality-sensitive behavior parameters.

2. The emotion representation system according to claim 1, wherein the behavior selection module, according to the emotion parameter, locates a plurality of first emotions relevant to the emotion parameter from the behavior database, and selects a second emotion from the first emotions, the second emotion is closest to the input emotion for selecting the set of behavior parameters corresponding to the second emotion.

3. The emotion representation system according to claim 2, wherein the behavior selection module further locates the first emotions according to the average value and standard error of a plurality of emotion stored in the behavior database.

4. The emotion representation system according to claim 2, wherein the behavior selection module calculates the distance from the first emotions to the input emotion and selects the set of behavior parameters closest to the second emotion.

5. The emotion representation system according to claim 4, wherein the behavior selection module calculates the distance from the first emotions to the input emotion according to a distance formula.

6. The emotion representation system according to claim 2, wherein the behavior selection module calculates the probability of the input emotion falling within the first emotions, and selects the set of behavior parameters of the second emotion with maximum probability.

7. The emotion representation system according to claim 6, wherein the behavior selection module calculates the probability of the input emotion falling within the first emotions according to a Gaussian distribution.

8. The emotion representation system according to claim 1, wherein the set of behavior parameters comprises a plurality of behavior parameters, the behavior modification module comprises:
a plurality of behavior parameter modification units used for modifying the behavior parameters according to the personality parameter respectively.

9. The emotion representation system according to claim 8, wherein the behavior parameters comprises a speed rate behavior parameter, the behavior parameter modification units at least comprise:
a speed modification unit used for modifying the speed rate behavior parameter.

10. The emotion representation system according to claim 8, wherein the behavior parameters comprises a response time behavior parameter, and the behavior parameter modification units at least comprise:
a response time modification unit used for modifying the response time behavior parameter.

11. The emotion representation system according to claim 8, wherein the behavior parameters comprises a behavior size behavior parameter, and the behavior parameter modification units at least comprise:
a behavior size modification unit used for modifying the behavior size behavior parameter.

12. The emotion representation system according to claim 1, wherein the behavior modification module modifies the set of behavior parameters as a set of modified behavior parameter according to the personality parameter, and determines whether the set of modified behavior parameter is within a pre-determined range, if no, the set of personality-sensitive behavior parameters equals the extremum of the set of modified behavior parameter, if so, the set of personality-sensitive behavior parameters equals the set of modified behavior parameter.

13. A personality-sensitive emotion representation method, comprising:
(a) selecting a set of behavior parameters from a behavior database according to an emotion parameter, which represents an input emotion; and
(b) modifying the set of behavior parameters according to a personality parameter so as to output a set of personality-sensitive behavior parameters.

14. The emotion representation method according to claim 13, wherein the step (a) comprises:
(a1) locating a plurality of first emotions relevant to the emotion parameter from the behavior database according to the emotion parameter;
(a2) selecting a second emotion closest to the input emotion from the first emotions; and
(a3) selecting the set of behavior parameters corresponding to the second emotion.

15. The emotion representation method according to claim 14, wherein the step (a1) further locates the first emotions according to the average value and standard error of a plurality of emotions stored in the behavior database.

16. The emotion representation method according to claim 14, wherein the step (a2) comprises:
(a2-1) calculating the distance from the first emotions to the input emotion; and
(a2-2) selecting the set of behavior parameters closest to the second emotion.

17. The emotion representation method according to claim 16, wherein the distance from the first emotions to the input emotion is obtained through a distance formula.

18. The emotion representation method according to claim 14, wherein the step (a2) comprises:
(a2-1) calculating the probability of the input emotion falling within the first emotions; and
(a2-2) selecting the set of behavior parameters of the second emotion with maximum probability.

19. The emotion representation method according to claim 18, wherein the probability of the input emotion falling within the first emotions is obtained through a Gaussian distribution.

20. The emotion representation method according to claim 13, wherein the step (b) comprises:
(b1) modifying a speed rate behavior parameter of the set of behavior parameters according to the personality parameter.

21. The emotion representation method according to claim 13, wherein the step (b) comprises:
(b1) modifying a response time behavior parameter of the set of behavior parameters according to the personality parameter.

22. The emotion representation method according to claim 13, wherein the step (b) comprises:
(b1) modifying a behavior size behavior parameter of the set of behavior parameters according to the personality parameter.

23. The emotion representation method according to claim 13, wherein the step (b) comprises:
(b1) modifying the set of behavior parameters as a set of modified behavior parameter according to the personality parameter;
(b2) determining whether the set of modified behavior parameter is within a pre-determined range;
(b3) if no, the set of personality-sensitive behavior parameters equals the extremum of the set of modified behavior parameter; and
(b4) if so, the set of personality-sensitive behavior parameters equals the set of modified behavior parameter.
